(19) United States
(12) Patent Application Publication
(10) Pub. No.: US 2017/0134486 A1
(43) Pub. Date: May 11, 2017

(54) METHOD AND DEVICE FOR INFORMATION SYNCHRONIZATION

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Dehui HUANG, Tianjin (CN); Xun XU, Tianjin (CN); Weizong HOU, Tianjin (CN); Xitao LIU, Tianjin (CN)

(21) Appl. No.: 15/245,130

(22) Filed: Aug. 23, 2016

Related U.S. Application Data
(63) Continuation of application No. PCT/CN2016/087059, filed on Jun. 24, 2016.

(30) Foreign Application Priority Data
Nov. 10, 2015 (CN) 201510761966.1

(51) Int. Cl. H04L 29/08; H04L 12/911

(52) U.S. Cl. CPC H04L 67/1095; H04L 67/26; H04L 47/70

(57) ABSTRACT

Disclosed are an information synchronization method and an information synchronization device. The method includes steps of receiving an information processing request, wherein the information processing request at least include resource information and corresponding user identifier information; determines at least two clients corresponding to the user identifier information and sending the resource information to the at least two clients. The embodiment of the present disclosure acquires the correspondence between the resource information and the user identifier information, finds out the clients corresponding to the user identifier information, and pushes the resource information to the clients, realizing synchronization of the resource information among the clients corresponding to the user identifier information, so the resources on the clients are consistent in state. The method avoids the disorder caused by difference notifications received by different smart terminals, and improves user experience.

### CROSS-REFERENCE TO RELATED APPLICATIONS

The present disclosure is a continuation of International Application No. PCT/CN2016/087059, filed on Jun. 24, 2016; which is based upon and claims priority to Chinese Patent Application No. 201510761966.1, entitled “METHOD AND DEVICE FOR INFORMATION SYNCHRONIZATION”, filed on Nov. 10, 2015 to the State Intellectual Property Office, the entire contents of all of which are incorporated herein by reference.

### TECHNICAL FIELD

The present invention relates to the technical field of information processing, in particular to an information synchronization method and an information synchronization device.

### BACKGROUND

Along with the rapid development of Internet technologies and mobile communication technologies, more and more people use terminal devices such as super TVs, smart mobile phones and tablet computers to acquire network resources. For example, super TVs and smart mobile phones all have video resources. wherein for requested video resources, users just need to find out and play the required videos; for live video programs, users can click and watch live programs and can also look back after the live broadcast ends. Users can also mark interesting videos, for example concerning and collecting the interesting videos, and can also make a reservation of play of those programs.

Reservation play is taken as an example. When a user make a reservation of “Live Vocal Concert of Faye Wong at 22:00” in a video play client on a mobile phone, the video play client on the mobile phone prompts the user to watch the reserved program at a preset time before 22:00. Alternatively, when the reserved program changes, the video play client pushes a notification to the user to inform the user of changes in the reserved program. This greatly improves user experience.

However, more and more smart terminals are available, it is very likely that the operations such as reservation and concerning done by users on different smart terminals are not synchronous, which results in that different smart terminals receive different notifications, tending to cause disorder and degrade user experience.

Therefore, information synchronization among different terminals is an issue needed to be solved urgently in the field at present.

### SUMMARY

An embodiment of the present disclosure discloses an information synchronization method and an information synchronization device, capable of realizing information synchronization among different terminals.

According to one aspect of the present invention, an embodiment of the present invention discloses an information synchronization method, including:

receiving a processing request on designated resource, wherein the processing request includes the resource information of the designated resources;

acquiring the user identifier information corresponding to processing request;

generating an information processing request according to the resource information and the user identifier information;

sending the information processing request to a push center such that the push center determines at least two clients corresponding to the user identifier information and sends the resource information to the at least two clients.

According to another aspect of the present disclosure, an embodiment of the present disclosure discloses an electronic device, including: at least one processor, and a memory communicably connected with the at least one processor for storing instructions executable by the at least one processor, wherein execution of the instructions by the at least one processor causes the at least one processor to:

receive a processing request on designated resource, wherein the processing request includes the resource information of the designated resources;

acquire the user identifier information corresponding to processing request;

generate an information processing request according to the resource information and the user identifier information;

send the information processing request to a push center such that the push center determines at least two clients corresponding to the user identifier information and sends the resource information to the at least two clients.

According to a third aspect, the present invention provides a non-volatile computer readable storage medium, where the non-volatile computer readable storage medium stores a computer instruction, and a computer executes the computer instruction to execute the following operations: receiving a processing request on designated resource, wherein the processing request includes the resource information of the designated resources;

acquiring the user identifier information corresponding to processing request;

generating an information processing request according to the resource information and the user identifier information;

sending the information processing request to a push center such that the push center determines at least two clients corresponding to the user identifier information and sends the resource information to the at least two clients.

The present disclosure has the following beneficial effects:

the embodiment of the present disclosure acquires the correspondence between the resource information and the user identifier information, finds out the clients corresponding to the user identifier information, and pushes the resource information to the clients, realizing synchronization of the resource information among the clients corresponding to the user identifier information, so the resources on the clients are consistent in state. The method avoids the disorder caused by difference notifications received by different smart terminals, and improves user experience.

The above description is a summary of the solution of the present disclosure. In order to more clearly describe the technical means of the present disclosure, the content of the description can be executed. Moreover, in order to make the above and other objectives, characteristics and advantages of the present disclosure more understandable, embodiments of the present disclosure are described below.

### BRIEF DESCRIPTION OF THE DRAWINGS

To more clearly describe the technical solution in the embodiments of the present disclosure or in the prior art, the following are brief introduction of the attached drawings used to describe the technology in the embodiments or in the prior art. Obviously, the attached drawings described below involve some embodiments of the present disclosure. For those originally skilled in this field, other drawings can be made according to those drawings without creative labor.

FIG. 1 is a step flow chart of an information synchronization method according to an embodiment of the present disclosure.

FIG. 2 is a step flow chart of an information synchronization method according to another embodiment of the present disclosure.

FIG. 3 is a step flow chart of an information synchronization method according to another embodiment of the present disclosure.

FIG. 4 is a schematic view of information synchronization according to the present disclosure.

FIG. 5 is a step flow chart of an information synchronization method according to another embodiment of the present disclosure.

FIG. 6 is a structural block diagram of an information synchronization device according to an embodiment of the present disclosure.

FIG. 7 is a structural block diagram of an information synchronization device according to another embodiment of the present disclosure.

FIG. 8 schematically illustrates a block diagram of an electronic device for executing the steps of the method according to the present disclosure.

### DETAILED DESCRIPTION

To make the objectives, technical solutions and advantage of the embodiments of the present disclosure more clear, the technical solutions in embodiments of the present disclosure are clearly and completely described below with reference to drawings in the embodiments of the present disclosure. Obviously, the described embodiments are some embodiments of the present disclosure, not all the embodiments of the present disclosure. Based on the embodiments in the present disclosure, those ordinarily skilled in this field can obtain other embodiments without creative labor, which shall fall within the protection scope of the present disclosure.

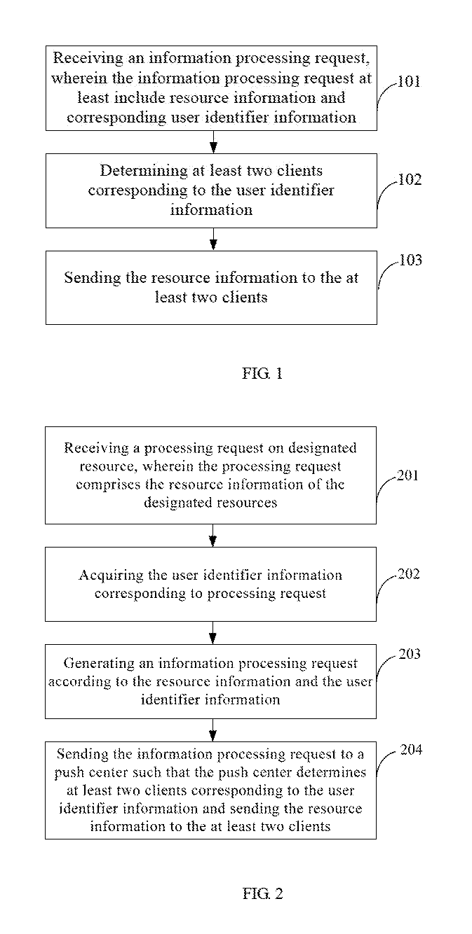

Refer to FIG. 1, which illustrates a step flow chart of a step flowchart of an information synchronization method according to one embodiment of the present disclosure. The method may specifically include the following steps.

Step 101: Receive an information processing request, wherein the information processing request at least include resource information and corresponding user identifier information.

In this embodiment of the present disclosure, the device for information synchronization (hereinafter referred as the device) can specifically be a push center, etc.

The device can specifically receive an information processing request sent by a concern and reservation center service terminal, and the information processing request can include resource information and corresponding user identifier information, and the resource information includes resource state information and resource identifier information. The resource state information represents the concern and reservation state of resources. for example, concerned, reserved, unconcerned, or unreserved state, etc. The resource identifier information is applicable to identification of, resource ID for example, of recourses, and the user identifier information can be a login account number of the user.

The device can also receive the information processing request sent by a message middleware, wherein the information processing request can include resource information and corresponding user identifier information, and the resource information includes resource change information and resource identifier information. Wherein, the resource change information includes notifications of resource changes such as resource update.

Step 102: Determine at least two clients corresponding to the user identifier information.

After receiving the information processing request sent by the concern and reservation center service terminal or the message middleware, the device can determine a plurality of or all clients registered using the user identifier information according to the user identifier information included in the request, wherein the number of clients is at least two.

Step S103: Send the resource information to the at least two clients.

In this step, the device can send the resource information to a plurality of determined clients, and the resource information can be resource state information and resource identifier information, or resource change information and resource identifier information.

After receiving the resource information. each client can find out corresponding resource according to the resource identifier information, and change the state of the corresponding resources according to the resource state information, for example the concern and reservation states, or find out the corresponding resources according to the resource identifier information, and change the resource contents, etc. according to the resource change information, for example change of the broadcast time or broadcast contents. In this way, information synchronization among the clients corresponding to the user identifier information can be achieved.

The embodiment of the present disclosure acquires the correspondence between the resource information and the user identifier information, finds out the clients corresponding to the user identifier information, and pushes the resource information to the clients, realizing synchronization of the resource information among the clients corresponding to the user identifier information, so the resources on the clients are consistent in state. The method avoids the disorder caused by difference notifications received by different smart terminals, and improves user experience.

Refer to FIG. 2, which is a step flow chart of an information synchronization device according to another embodiment of the present disclosure.

According to this embodiment, the device for information synchronization is an opposite end of an executive body of the above embodiment, and can specifically a message middleware or a concern and reservation center service terminal. The method can specifically include the following steps.

Step 201: Receive a processing request on designated resources, wherein the processing request includes the resource information of the designated resources.

According to this embodiment, the information synchronization device first receives a processing request for designated resources sent by a certain client or an operation administration background, wherein the processing request includes the resource information of the designated resources. The processing requests sent by different terminals vary with resource information. The resource information at least includes the resource identifier information of the designated resources.

Step 202: Acquire the user identifier information corresponding to processing request.

After the processing request is received, if the sending terminal is a client of the user, the user identifier information corresponding to the processing request can be directly acquired, and if the sending terminal is an operation administration background, a request can be sent to a server, which stores the correspondence between the resource identifier information and the user identifier information to acquire corresponding user identifier information.

Step 203: Generate an information processing request according to the resource information and the user identifier information.

After the user identifier information is acquired, an information processing request can be generated according to the resource information and the user identifier information.

Step 204: Send the information processing request to a push center such that the push center determines at least two clients corresponding to the user identifier information and sends the resource information to the at least two clients.

After the information processing request including the resource information and the user identifier information is sent to the push center, the push center can send the resource information at the at least two clients by the method described through steps 101-103, realizing resource information synchronization among a plurality of clients.

The embodiment of the present disclosure realizes correlation between the resource information and the user identifier information through acquiring the resource information and the corresponding user identifier information, providing guarantee for the push center to push the resource information to a plurality of clients. The method realizes synchronization of the resource information among the clients corresponding to the user identifier information, so the resources on the clients are consistent in state. The method avoids the disorder caused by difference notifications received by different smart terminals, and improves user experience.

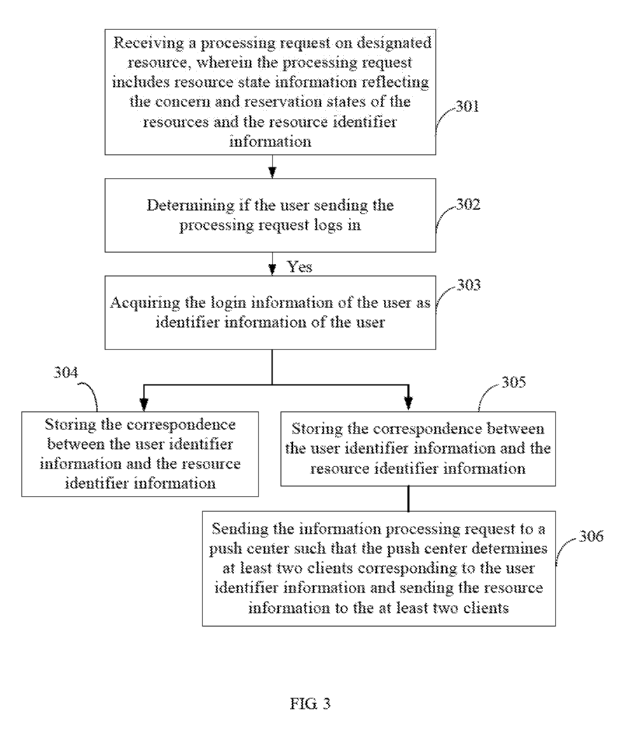

Refer to FIG. 3, which is a step flowchart of an information synchronization method according to another embodiment of the present disclosure.

This embodiment is described by taking the concern and reservation center server terminal as the executive body. The method can specifically include the following steps.

Step 301: Receive a processing request on designated resource, wherein the processing request includes resource state information reflecting the concern and reservation states of the resources and the resource identifier information.

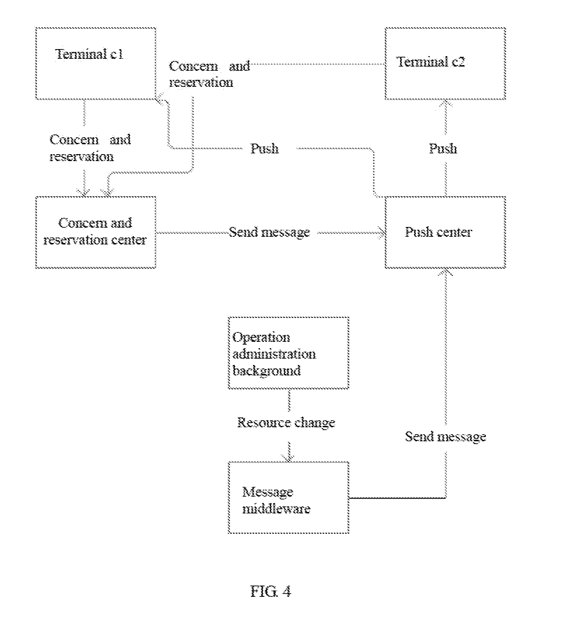

In this step, the concern and reservation center service terminal first receives the processing request on designated resources sent by a client. As shown in FIG. 4, the concern and reservation center service terminal receives the processing request on concerning (or reservation, or unconcerning, or reservation canceling) of designated resources sent by a terminal C1.

The processing request includes the resource information of the designated resources, which can specifically be the resource identifier information and resource state information of the designated resources. The resource state information represents the concern and reservation state of resources, for example, concerned, or reserved, or unconcerned, or unreserved state, etc.

After receiving the processing request, the concern and reservation center service terminal continues to acquire the user identifier information corresponding to the processing request. The process includes the following steps 302-303.

Step 302: Determine if the user sending the processing request has logged in.

The concern and reservation center service terminal can acquire user sso_token (Single Sign-On token) among parameters of the processing request, verifies if the user logs in the authentication center by using the sso_token, if so, executes Step 303, and if not, feeds an error code to the terminal C1 to prompt that the user is needed to log in the application to concern and reserve designated resources.

Step 303: Acquire the login information of the user as identifier information of the user.

After confirming that the user has logged in, the service terminal can define the login information of the user as identifier information of the user.

After acquiring the identifier information of the user, the service terminal can respectively execute Step 304 and Step 305.

Step 304: Store the correspondence between the user identifier information and the resource identifier information.

The concern and reservation center service terminal locally stores or remotely uploads the correspondence between the user identifier information and the resource identifier information for convenient search of resources corresponding to the user identifier information and users corresponding to the resources later.

Step 305: Generate an information processing request according to the resource information and the user identifier information.

After the user identifier information is acquired, an information processing request can be generated according to the resource information and the user identifier information.

Step 306: Send the information processing request to a push center such that the push center determines at least two clients corresponding to the user identifier information and sends the resource information to the at least two clients.

Steps 305-306 are similar to steps 203-204 in the previous embodiment and therefore are not repeatedly described here.

After receiving the information processing request. the push center can determine a plurality of clients corresponding to the user identifier information, and then can push the resource information to the plurality of clients. As shown in FIG. 4, the push center can push the resource information to the terminal C1 and the terminal C2 after acquiring the clients on the terminal C1 and the terminal C2 corresponding to the user identifier information, and the clients can find corresponding resources according to the resource identifier information after receiving the resource information and sets the resources according to the resource state information, for example concern and reservation. The push center can also screen the clients to which the resource information is pushed to avoid repeated pushing or repeated resource setting.

Likewise, when the clients on the terminal C2 sends the processing request on designated resources, the concern and reservation center service terminal performs the above mentioned processing and then can send an information processing request to the push center. The push center also pushes the resource information to the clients on the terminal C1.

Refer to FIG. 5, which is a step flow chart of an information synchronization method according to another embodiment of the present disclosure.

This embodiment is described by taking the message middleware as the executive body. The method can specifically include the following steps.

Step 501: Receive a processing request on designated resource, wherein the processing request includes the resource change information and the resource identifier information.

In this step, as shown in FIG. 4, the message middleware can receive the processing request on the designated resources from the operation administration background first. The processing request includes the resource change information and the resource identifier information. Wherein, the resource change information includes details of resource change, for example, broadcast time, broadcast contents, etc.

Step 502: Acquire the user identifier information corresponding to the resource identifier information from the service terminal which, stores the correspondence between the resource identifier information and the user identifier information in advance.

The message middleware acquires the user identifier information corresponding to processing request after receiving the processing request. In this step, the message middleware can acquire the user identifier information corresponding to the resource identifier information from the service terminal, which stores the correspondence between the resource identifier information and the user identifier information in advance, according to the resource information included in the processing request. For example, the message middleware can request the concern and reservation center service terminal for the user identifier information corresponding to the resource identifier information.

Step 503: Generate an information processing request according to the resource information and the user identifier information.

After the user identifier information is acquired, the message middleware can generate an information processing request according to the resource information and the user identifier information.

Step 504: Send the information processing request to a push center such that the push center determines at least two clients corresponding to the user identifier information and sends the resource information to the at least two clients.

The message middleware can push the resource information to all clients corresponding to the user identifier information. As shown in FIG. 4, the message middleware pushes the resource information to the clients on the terminals C1 and C2.

After receiving the resource information, each client can find corresponding resources according to the resource identifier information therein, and use the resource change information to change the contents of the resources found.

It is needed to be noted that, for simple description, the method embodiments are described as a series of action combinations, but those skilled in this field understand that the embodiments of the present disclosure are not limited by the sequence of the described actions because according to the embodiments of the present disclosure, some steps can be implemented in other sequence or at the same time. Moreover, those skilled in this field also understand that the embodiments described in the specification are all optimal embodiments, and some actions involved are not always needed by the embodiments of the present disclosure.

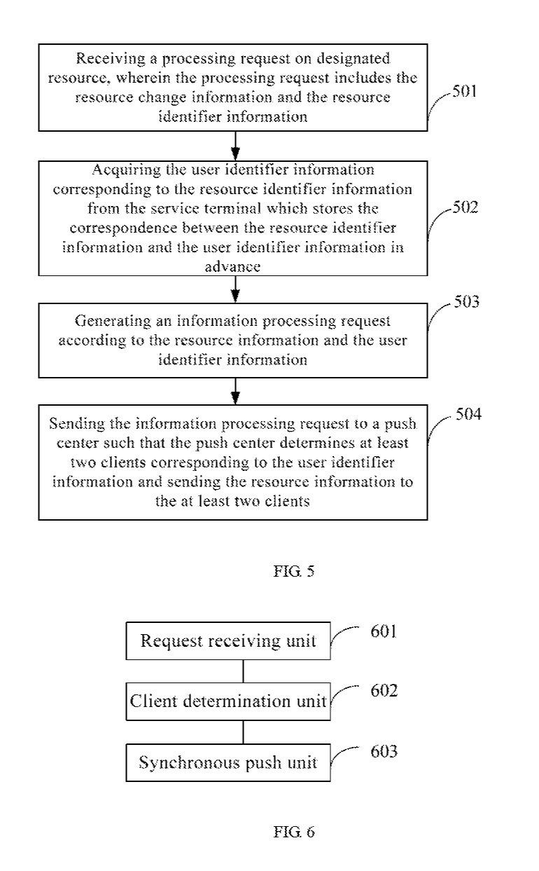

Refer to FIG. 6, which is a structural block diagram of an information synchronization device according to an embodiment of the present disclosure. The device can specifically include:

a request receiving unit 601 for receiving an information processing request, wherein the information processing request at least include resource information and corresponding user identifier information;

a client determination unit 602 for determining at least two clients corresponding to the user identifier information;

a synchronous push unit 603 for sending the resource information to the at least two clients.

Through the above units, the embodiment of the present disclosure acquires the correspondence between the resource information and the user identifier information, finds out the clients corresponding to the user identifier information, and pushes the resource information to the clients, realizing synchronization of the resource information among the clients corresponding to the user identifier information. so the resources on the clients are consistent in state. The device avoids the disorder caused by difference notifications received by different smart terminals, and improves user experience.

According to another embodiment of the present disclosure, the request receiving unit 601 can be used for receiving the information processing request sent by the concern and reservation center service terminal, wherein the information processing request includes the resource state information reflecting the resource state information of the resources in the concerned and reserved state, resource identifier information and user identifier information corresponding to the resource identifier information, or the request receiving unit 601 can also be used for receiving the information processing request sent by the message middleware, wherein the information processing request includes the resource change information, resource identifier information and user identifier information corresponding to the resource identifier information.

In the above embodiment, the information synchronization device can specifically be a push center.

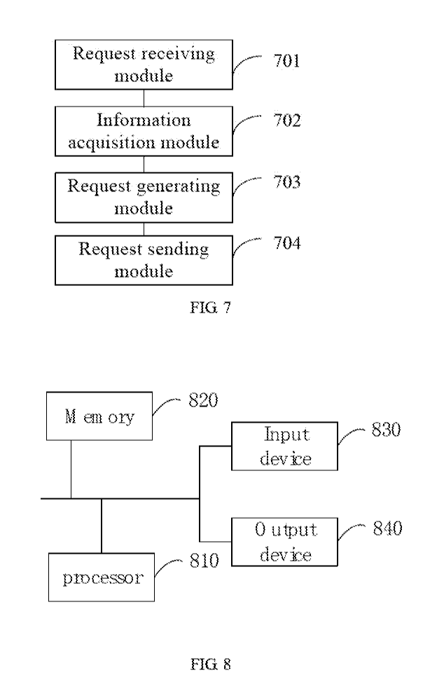

Refer to FIG. 7, which is a structural block diagram of an information synchronization device according to another embodiment of the present disclosure. The device can specifically include the following modules:

a request receiving module 701 for receiving a processing request on designated resources, wherein the processing request includes the resource information of the designated resources;

an information acquisition module 702 for acquiring the user identifier information corresponding to processing request;

a request generation module 703 for generating an information processing request according to the resource information and the user identifier information;

and a request sending module 704 for sending the information processing request to a push center such that the push center determines at least two clients corresponding to the user identifier information and sends the resource information to the at least two clients.

Through the above units. the embodiment of the present disclosure realizes correlation between the resource information and the user identifier information through acquiring the resource information and the corresponding user identifier information, providing guarantee for the push center to push the resource information to a plurality of clients. The method realizes synchronization of the resource information among the clients corresponding to the user identifier information, so the resources on the clients are consistent in state. The device avoids the disorder caused by difference notifications received by different smart terminals, and improves user experience.

In another embodiment, the information synchronization device can specifically be a concern and reservation service terminal. The resource information can include resource state information reflecting the concern and reservation states of the resources and the resource identifier information.

The information acquisition module 702 can further include:

a determination sub-module for determining if the user sending the processing request has logged in;

and an acquisition sub-module for acquiring the login information of the user as identifier information of the user when the determination sub-module determines that the user has logged in.

The device can also further include:

a storage module for storing the correspondence between the user identifier information and the resource identifier information.

In another embodiment, the information synchronization device can be specifically a message middleware, and the resource information can include resource change information and resource identification information.

The information acquisition module 702 can be used for acquiring the user identifier information corresponding to the resource identifier information from the service terminal, which stores the correspondence between the resource identifier information and the user identifier information in advance.

The device embodiment is basically the same as the method embodiments and therefore is simply described. Related contents can be seen in the related description of the method embodiments.

The device embodiment described above is schematic, wherein units described as separable parts may be or may not be physically separated, and components displayed as units may be or may not be physical units, which means that the units can be positioned at one place or distributed on a plurality of network units. Some or all modules can be selected to fulfill the objective of the solution in the embodiment upon actual demands. Those ordinarily skilled in this field can understand and implement the present disclosure without creative work.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

Embodiments of the present disclosure further provide a non-volatile computer-readable storage medium, the non-volatile computer-readable storage medium is stored with computer executable instructions which are configured to perform any of the embodiments described above of the method for adjusting a video.

FIG. 8 illustrates a block diagram of an electronic device for executing the method according the disclosure, such as an application server. As shown in FIG. 8, the electronic device includes:

one or more processors 810 and memories 820, in FIG. 8, one processor 810 is taken as an example.

The electronic device for executing the method for adjusting the video may include: an input device 830 and an output device 840.

The processor 810, the memory 820. the input device 830 and the output device 840 are connected through buses or other connecting ways. In FIG. 8, a bus connection is taken as an example.

The memory 820 is a non-transitory computer readable storage medium which may be used to store non-transitory software program, non-transitory computer-executable program and modules such as the program instructions/modules (such as the a request receiving unit 601, client determination unit 602, synchronous push unit 603 shown in FIG. 6) corresponding to the method for adjusting the video according to the embodiment of the present disclosure. The processor 810 executes various functions and applications of the electronic device and performs data processing by operating the non-transitory software programs, instructions and modules stored in the memory 820, that is, executes the method for adjusting the video according to the method embodiments above.

The memory 820 may include a program storage section and a data storage section. Wherein the program storage section may store operating system and application needed by at least one function, and the data storage section may store the established data according to the device for adjusting the video. In addition, the memory 820 may include a high-speed random access memory, and may also include a non-transitory memory such as at least a disk memory device, flash memory device or other non-transitory solid-state storage devices. In some embodiments, the memory 820 may include a remote memory away from the processor 810. The remote memory may be connected to the device for adjusting the video via network. The network herein may include Internet, interior network in a company, local area network, mobile communication network and the combinations thereof.

The input device 830 may receive input numbers or characteristics information, and generate key signal input relative to the user setting and function control of the device for adjusting the video. The output device 840 may include display devices such as a screen.

The one or more modules are stored in the memory 820, when executed by the one or more processors 810, the methods for adjusting the video in the above method embodiments are executed.

The product may execute the method provided according to the embodiment of the present disclosure, and it has corresponding functional modules and beneficial effects corresponding to the executed method. The technical details not illustrated in the current embodiment may be referred to the method embodiments of the present disclosure.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of devices include audio players, video players (such as an iPod), handheld game players, e-books, intelligent toy, and portable vehicle-mounted navigation devices;

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiment(s) described above is (are) only schematic, the units illustrated as separated parts may be or may not be separated physically. and the parts shown in unit may be or may not be a physical unit. That is, the parts may be located at one place or distributed in multiple network units. A skilled person in the art may select part or all modules therein to realize the objective of achieving the technical solution of the embodiment.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM. magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. An information synchronization method, applied at an electronic device, comprising:
receiving a processing request on designated resource, wherein the processing request comprises the resource information of the designated resources;
acquiring the user identifier information corresponding to processing request;
generating an information processing request according to the resource information and the user identifier information;
sending the information processing request to a push center such that the push center determines at least two clients corresponding to the user identifier information and sends the resource information to the at least two clients.

2. The method according to claim 1, wherein the resource information comprises resource state information reflecting the concern and reservation states of the resources and the resource identifier information;
wherein acquiring the user identifier information corresponding to processing request comprises:
determining if the user sending the processing request logs in;
and if so, acquiring the login information of the user as identifier information of the user.

3. The method according to claim 2, wherein the method further comprises:
storing the correspondence between the user identifier information and the resource identifier information.

4. The method according to claim 1, wherein the resource information comprises resource change information and resource identifier information;
acquiring the user identifier information corresponding to processing request comprising:
acquiring the user identifier information corresponding to the resource identifier information from the service terminal, which stores the correspondence between the resource identifier information and the user identifier information in advance.

5. An electronic device, comprising:
at least one processor, and
a memory communicably connected with the at least one processor for storing instructions executable by the at least one processor, wherein execution of the instructions by the at least one processor causes the at least one processor to:
receive a processing request on designated resource, wherein the processing request includes the resource information of the designated resources;
acquire the user identifier information corresponding to processing request;
generate an information processing request according to the resource information and the user identifier information;
send the information processing request to a push center such that the push center determines at least two clients corresponding to the user identifier information and sends the resource information to the at least two clients.

6. The electronic device according to claim 5, wherein the resource information comprises resource state information reflecting the concern and reservation states of the resources and the resource identifier information;
wherein acquiring the user identifier information corresponding to processing request comprises:
determining if the user sending the processing request logs in;
and if so, acquiring the login information of the user as identifier information of the user.

7. The electronic device according to claim 6, further comprises:
storing the correspondence between the user identifier information and the resource identifier information.

8. The electronic device according to claim 5, wherein the resource information comprises resource change information and resource identifier information;
wherein acquiring the user identifier information corresponding to processing request comprises: acquiring the user identifier information corresponding to the resource identifier information from the service terminal, which stores the correspondence between the resource identifier information and the user identifier information in advance.

9. A non-volatile computer readable medium, where the non-volatile computer readable storage medium stores a computer instruction, and a computer executes the computer instruction to execute the following operations:
receiving a processing request on designated resource, wherein the processing request comprises the resource information of the designated resources;
acquiring the user identifier information corresponding to processing request;
generating an information processing request according to the resource information and the user identifier information;
sending the information processing request to a push center such that the push center determines at least two clients corresponding to the user identifier information and sends the resource information to the at least two clients.

10. The non-volatile computer readable medium according to claim 9, wherein the resource information comprises resource state information reflecting the concern and reservation states of the resources and the resource identifier information;
wherein acquiring the user identifier information corresponding to processing request comprises:
determining if the user sending the processing request logs in;
and if so, acquiring the login information of the user as identifier information of the user.

11. The non-volatile computer readable medium according to claim 10, wherein the electronic device is further caused to:
store the correspondence between the user identifier information and the resource identifier information.

12. The non-volatile computer readable medium according to claim 9, wherein the resource information comprises resource change information and resource identifier information;
acquiring the user identifier information corresponding to processing request comprises:
acquiring the user identifier information corresponding to the resource identifier information from the service terminal, which stores the correspondence between the resource identifier information and the user identifier information in advance.
